(19) United States
(12) Patent Application Publication
(10) Pub. No.: US 2008/0185027 A1
(43) Pub. Date: Aug. 7, 2008

(54) Glass furnace cleaning system

(76) Inventors: Donald E. Shamp, Millbury, OH (US); Carl M. Byers, Cadiz, OH (US); Fred G. Guthrie, Scio, OH (US); Scott L. Henry, Jewett, OH (US); Gary L. Richardson, Mt. Sterling, OH (US); David Paul Zantene, Midvale, OH (US); Douglas Allan Satterfield, Jewett, OH (US)

Correspondence Address: EMCH, SCHAFFER, SCHAUB & PORCELLO CO, P O BOX 916, ONE SEAGATE SUITE 1980, TOLEDO, OH, 43697, US

(21) Appl. No.: 11/703,460

(22) Filed: Feb. 6, 2007

(51) Int. Cl. B08B 9/04; B08B 3/00

(52) U.S. Cl. 134/105; 134/8

(57) ABSTRACT

A high pressure cleaning system for removing deposits from glass furnaces.

### BACKGROUND OF THE INVENTION

This invention relates to the glass making industry and more specifically glass refractory regenerators and the glass furnaces therein. The present invention is a system that can be used for cleaning chimneys or “checkers” that are components of refractory regenerators. Refractory regenerators are designed and constructed with hundreds of small chimneys, which are sometimes called “checkers” by those skilled in the art. These checkers act as heat exchangers whereas the walls of the chimneys absorb heat when exhaust gases pass through them and then return that heat to incoming combustion air, heating it up before the gas for the combustion process is inserted during reversal of the furnace's combustion cycle. During this process of combustion reversal, a small amount of carryover is blown off the surface of the melting batch of glass in the furnace and onto the tops of the checkers. The amount of carryover varies depending upon the design of the furnace and the velocity of the gases on the surface, the amount of water or batch wetting being done, the chemical makeup of the batch, the type of batch materials, and the batch grain size being used. For example, if a great deal of decrepitation is taking place from the amount and/or type of limestone being used then the amount of carryover will be increased. In addition to this batch carryover, there is also a degree of spalling that takes place from the hot face of the refractory regenerator superstructure which may collect on the checkers and mix with the batch carryover. This carried over material on the top of the checkers reduces the size of the checker openings, thereby reducing the efficiency of the structure by decreasing its ability for efficient heat recovery. In addition, dependent upon the size of the checker openings, the carried over material may bridge across the opening closing it off completely.

In the past, the checkers were cleaned when necessary using compressed air and maintained on a regular schedule, typically in the range of every 3 to 6 months. In an effort to reduce production costs however, manufacturers have increased the time interval between cleaning regenerators. In addition, furnace rebuild campaigns have increased from 4 years to nearly 12 years through better refractory designs and improved controls. These factors have allowed an increased amount of debris to collect on the checker tops. Because of the increased amount of debris, the old method of cleaning with compressed air is no longer effective.

The present invention is a cleaning system that utilizes an ultra high pressure water laser that blasts and cuts the debris on the checker tops into small pieces allowing it to fall down to the bottom of the chimneys where it can be removed. In the past, there has been a hesitancy to use water on a hot refractory regenerator, but the present invention utilizes a low volume of water which quickly flashes to steam on contact with the hot regenerator surfaces.

### SUMMARY OF THE INVENTION

The present invention is a low volume, ultra high pressure water laser cleaning system for cleaning chimneys or checkers in a glass refractory. The cleaning system utilizes water pressures approaching 40,000 PSI and a water volume of 1 to 5 gallons per minute. This high pressure jet of water cuts deposited debris into small pieces and physically releases the deposits from the surfaces of the furnace checker tops. In addition to utilizing pressure to cut the debris, the water causes thermal shocking to occur on the debris that is effective in removing the top layers of the carryover debris or top most layers of “checker pack”. The invention utilizes water cooled lances of varying lengths which are inserted through openings or holes in the regenerator walls. These lances contain and protect the high pressure hoses and water laser nozzles making it possible to reach out into the 2800° F. atmosphere and do the blasting and cutting of the debris material while the furnace remains in production. The lances are designed in such a way to direct the water stream towards the surface to be cleaned making it possible to penetrate down the chimney a short distance to allow for a complete clearing of debris prior to moving to the next opening. In most applications the discharge nozzle from the lance is oriented to be substantially perpendicular to the longitudinal axis of the lance. However, it should be understood that the discharge nozzle can be positioned in any orientation that allows the discharge nozzle to effectively clean the furnace. The cleaning system of the present invention may operate at water pressures varying from 1000 to 40,000 PSI depending upon the thickness, chemical makeup, or hardness of the material being removed. The lance operator notifies the pump operator to adjust the pressure of the water supplied to the nozzle as needed.

Other objects and advantages of the present invention will become apparent to those skilled in the art upon a review of the following detailed description of the preferred embodiments and the accompanying drawings.

### BRIEF DESCRIPTION OF THE DRAWINGS

FIG. 1 is a drawing of the cleaning system's lance inserted into a glass furnace.

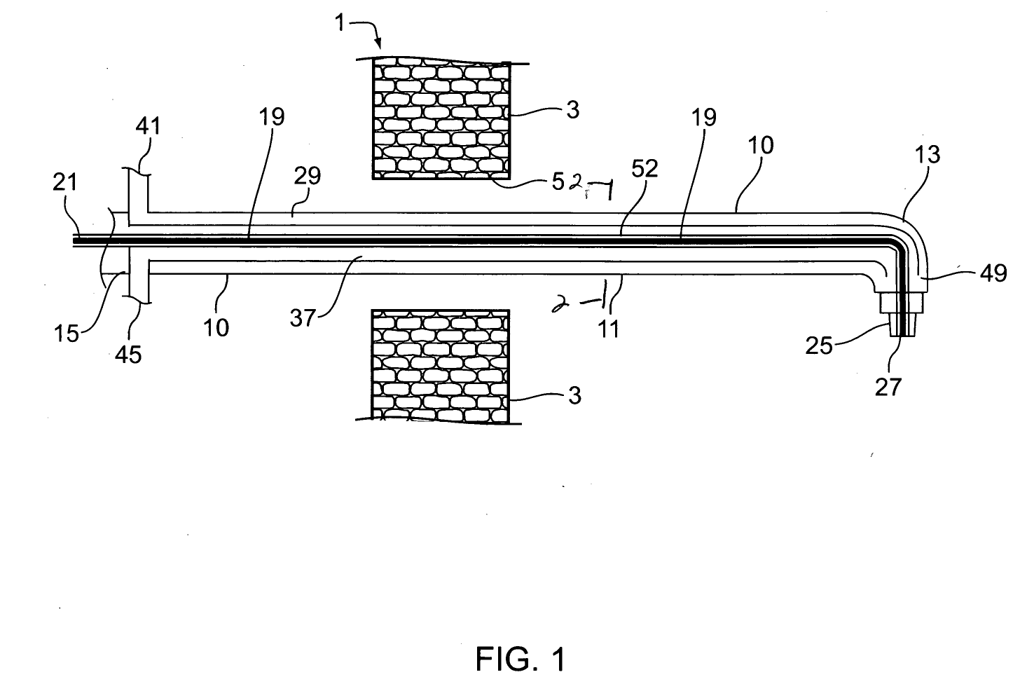

FIG. 2 is a cross sectional view of the lance taken along line 2-2 in FIG. 1.

### DETAILED DESCRIPTION OF THE PREFERRED EMBODIMENT(S)

The invention is directed to a device and method for cleaning deposits from a glass furnace. More particularly, the invention is directed to the use of a low volume, ultra high pressure water jet that can be used to clean glass furnaces or portions of glass furnaces while the furnace is being operated. The features of the invention will be more fully understood by reference to the attached drawings in connection with the following descriptive material.

A furnace 1 having a wall 3 is used to produce molten glass so that the molten glass can be formed into various objects that have commercial applications. More particularly, the area of the furnace 1 that is being described is the refractory regenerator portion of the glass furnace. The refractory regenerators are designed and constructed with hundreds of small chimneys which are sometimes called checkers by those skilled in the art. The checkers act as heat exchangers as the walls of the small chimneys absorb heat when exhaust gases pass through the chimneys and that absorbed heat is used to heat the combustion air that is provided to the glass furnace. The refractory regenerators allow the combustion air to be preheated and to return some of the heat from the exhaust of the glass furnace to be reutilized in the glass furnace. There are usually refractory regenerators on each side or ends of the glass furnace so that the regenerators are alternatively used for removing the hot exhaust gases or supplying the incoming combustion air. As described previously, deposits can form on the refractory generators that essentially reduces the size of the small chimneys or checkers that are present in the refractory regenerators. The deposits reduce the size of the small chimneys and reduce the efficiency of the regenerator structure for efficient heat recovery. Accordingly, there is a need in the industry to have an effective system for removing the deposits from the refractory regenerators to allow the glass furnace to operate in an efficient manner. Glass furnaces operate on a continuous basis and it is very experience and time consuming to shut down the glass furnace for maintenance or cleaning. Accordingly, there is a need for a way to clean the refractory regenerators while the furnace is being operated.

To clean the refractory regenerators of the glass furnace 1, a hole 5 can be provided or formed in the wall 3 of the glass furnace. The hole 5 provides access to the interior of the glass furnace and in particular the refractory regenerator portion of the glass furnace.

To accomplish the cleaning of the refractory regenerator a lance 10 is inserted in the hole 5 in the wall 3 of the furnace 1. The lance 10 has a first end 13 that extends into the glass furnace and a second end 15 which remains on the outside of the glass furnace 1. Typically, the lance 10 has a length that is usually from about 6 to about 45 feet in length. The lance 10 is usually generally cylindrical in shape and the diameter of the lance is from about 2 to about 5 inches. However, it should be understood that other shapes and sizes can be utilized for the lance 10 without departing from the scope of the invention. A passageway 19 extends down the center of the lance 10 from the second end 15 to the first end 13 of the lance. A supply opening 21 is provided on the second end of the lance 10 and the supply 21 is in communication with the passageway 19. A nozzle 25 is located on the first end 13 of the lance 10. A discharge aperture 27 is provided in the nozzle 25. The discharge aperture 27 usually has a diameter from about 0.01 to about 0.08 of an inch. In practice it has been found preferable for the discharge aperture to have a diameter from about 0.02 to about 0.04 of an inch. A source of high pressure cleaning fluid (not shown) is operatively connected to the supply opening 21 for the passageway 19. The high pressure cleaning fluid is directed along the passageway 19 to the discharge aperture 27 from the nozzle 25. The high pressure cleaning fluid is supplied to the passageway 19 at a rate of about 1 to about 5 gallons per minute with a rate of about 2 to about 3 gallons per minute being preferred. The high pressure cleaning fluid is supplied to the supply opening 21 in the passageway 19 at a pressure from about 1,000 to about 40,000 PSI. In practice it has been found preferable for the cleaning fluid to be supplied at a pressure of 5,000 to 10,000 PSI. The high pressure cleaning fluid is usually water, but other high pressure cleaning fluids can be utilized if desired.

In most applications the discharge nozzle 25 is located on the lance 10 in a manner where the discharge aperture 27 of the nozzle 25 is disposed in substantially perpendicular orientation to the passageway 19 that extends along the length of the lance 10. However, it should be understood that the nozzle 25 can be positioned in other orientations without departing from the scope of the invention.

The lance 10 is subjected to temperatures that can reach 3000° F. in the interior of the glass furnace 1. Because of the high temperatures that exist in the refractory regenerator area of the glass furnace it is desirable to cool the lance 10 so that it can function properly in the furnace environment. An outer chamber 29 is provided in the lance 10 around an inner chamber 37. An outlet 41 positioned on the second end 15 of the lance 10 is operatively connected to the outer chamber 29. An inner chamber is provided in the lance 10 around a protective jacket 52. The protective jacket 52 surrounds the passageway 19. An inlet 45 is operatively connected to the inner chamber 37. An opening 49 is provided in the end of the outer chamber 29 that is located in the first end 13 of the lance 10 adjacent the nozzle 25. The opening 49 operatively connects the outer chamber with the inner chamber 37. A source of cooling fluid (not shown) under pressure is operatively connected to the inlet 45. The cooling fluid supplied to the inlet 45 passes through the inner chamber 37 through the opening 49 and into the outer chamber 29. The cooling fluid is then discharged from the outer chamber 29 through the discharge 41. The cooling fluid that emerges from the discharge 41 can be cooled and recirculated through the inner and outer chambers or the cooling fluid can be deposed of and recirculated. In most applications the cooling fluid is water. In practice it has been found desirable to have a volume from about 50 to about 300 gallons per minute of cooling fluid supplied to the chamber 29 to effectively cool the lance 10 in the hot environment of the furnace 1.

In operation, the lance 10 is brought adjacent the furnace 1 and the cooling fluid is provided to the inlet 45 that is in communication with the inner chamber 37. The cooling fluid passes through the inner chamber 37 through the opening 49 and into the outer chamber 29. The cooling fluid exits the outer chamber 29 through the discharge 41. Once a sufficient volume of cooling fluid is moving through the inner and outer chambers to effectively cool the lance 10, the lance 10 can be inserted through the hole 5 and the wall 3 of the furnace 1. The lance 10 is positioned in the furnace 1 so that the discharge aperture 27 from the nozzle 25 is positioned adjacent an area that has deposits that need to be removed. Once the nozzle 25 is properly positioned the high pressure cleaning fluid is supplied through supply opening 21 to passageway 19 to the nozzle 25. The high pressure cleaning fluid is discharged from the discharge aperture 27 and the nozzle 25 so that the cleaning fluid is discharged at extremely high pressures onto the deposits that need to be cleaned. The high pressure cleaning fluid is discharged from the nozzle 25 at a pressure from about 1000 to about 10,000 PSI. However, do to the small size of the discharge aperture 27, only a small volume of cleaning fluid is discharged from the nozzle 25 into the furnace. The pressure of the cleaning fluid supplied to the passageway 19 can be regulated so that the pressure of the cleaning fluid discharged through discharge aperture 27 is supplied at a pressure that is adequate to remove the deposits without damaging the structure of the surrounding furnace. An operator is in contact with the second end 15 of the lance 10 and the operator can position the lance 10 in various locations of the furnace 1 to remove the deposits that have built up on the wall of the furnace. A device for rotating the lance can be operatively connected to the lance 10 to allow the operator to rotate the lance to position the nozzle 25 in desired locations within the furnace 1.

During operation of the lance 10 and the furnace 1 the cooling fluid is directed from the inlet 45 through the inner chamber 37 down to the opening 49 adjacent the nozzle 25, through the outer chamber 29 and through the discharge 41. This provides a constant source of cooling fluid for the lance 10 and allows the lance to properly function in the hostile and hot environment of an operating glass furnace. The high pressure jets of cleaning fluid from the nozzle 25 cut the deposits into small pieces and removes the deposits from the surface of the furnace or the refractory regenerators. The cleaning fluid that is discharged from the nozzle 25 is also at a much lower temperature than the walls of the furnace 1. The cleaning fluid causes a thermal shocking to occur when the cleaning fluid hits the debris on the walls of the furnace. The thermal shocking further assists in the removal of the debris from the walls of the furnace.

Once an area of the furnace has been effectively cleaned the supply of high pressure cleaning fluid to the passageway 19 can be turned off and the lance 10 can be moved to other areas of the furnace where the cleaning process can be repeated. Once the furnace 1 has been satisfactorily cleaned the supply of cleaning fluid for the passageway 19 is turned off and the lance 10 is removed from the furnace 1. The cooling fluid that is supplied to the inner and outer chambers will continue to be circulated until the lance 10 has been sufficiently cooled that the lance can be handled by the operators. Once the lance has been sufficiently cooled the supply of cooling fluid to the inner and outer chambers is turned off.

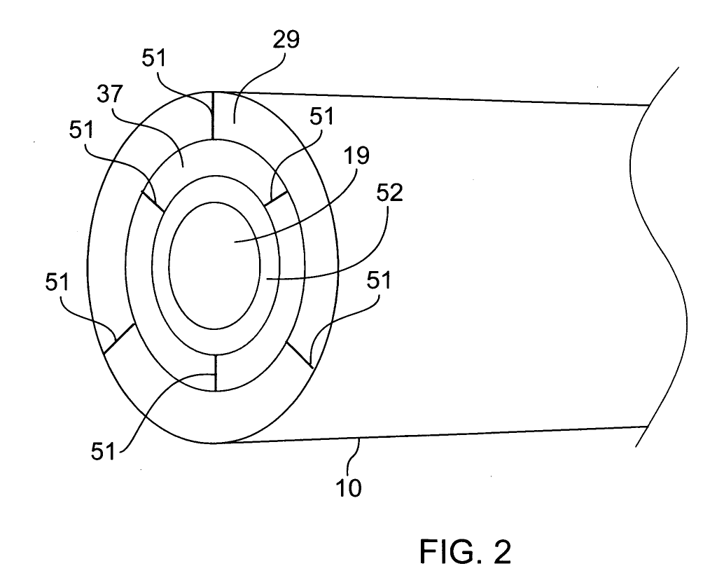

FIG. 2 show a cross section of the lance 10 with the outer cooling chamber 29 surrounding the inner cooling chamber 37. The outer cooling chamber 29 and the inner cooling chamber 37 contain stabilizer pins 51 to provide support and stability to the lance 10. The inner chamber 37 surrounds the protective jacket 52. The protective jacket 52 provides additional heat shielding to the passageway tube 19.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

We claim:

1. A high pressure cleaning system for removing deposits from glass furnaces comprising:
an elongated lance having a first end and a second end; a passageway positioned in the interior of the lance for the delivery of a cleaning fluid; the passageway extending from the first end to the second end of the lance, the second end of the lance having a nozzle operatively connected to the passageway whereby high pressure cleaning fluid is discharged from the nozzle to remove deposits from the glass furnace.

2. The system of claim 1 wherein the lance has a length that allows the nozzle to be positioned in various locations in the glass furnace structure to effectively clean the furnace.

3. The system of claim 2 wherein the lance has a length from about 6 to about 45 feet.

4. The system of claim 1 wherein the lance is cooled by a fluid to withstand the heat generated in the glass furnace.

5. They system of claim 4 wherein a chamber is formed around the passageway in the lance, a fluid being circulated in the chamber to remove heat from the glass furnace from the lance.

6. The system of claim 5 wherein the chamber has a first section that extends from the first end of the lance to the second end of the lance and a second section that extends from the second end of the lance to the first end of the lance, the second section being in fluid communication with the first section at the second end of the lance.

7. The system of claim 6 wherein a cooling fluid inlet is operatively connected to the first section of the chamber adjacent the first end of the lance and a cooling fluid discharge is operatively connected to the section of the chamber adjacent the first end of the lance whereby cooling fluid flows from the inlet at the first end of the lance to the second end of the lance in the first section and then flows from the second end of the lance to the first end of the lance to the discharge in the section whereby cooling fluid is circulated through the lance to remove heat from the lance.

8. The system of claim 1 wherein the nozzle has a discharge operative that is from about 0.01 to about 0.08 of an inch in diameter wherein the cleaning fluid from the passageway is discharged at a pressure from about 1,000 to about 40,000 PSI.

9. The system of claim 8 wherein the high pressure cleaning fluid is directed at the deposits at a low volume, the cleaning fluid being delivered from the nozzle from about 1 to about 5 gallons/hr.

10. A method for cleaning deposits from an operating glass furnace comprising:
positioning a lance having a nozzle on one end in a glass furnace;
supplying a cleaning fluid under pressure to the lance;
discharging the cleaning fluid from the nozzle towards the deposits to be removed from the furnace; and
directing a cooling fluid along the lance to remove sufficient heat to allow the lance to function in the environment of the glass furnace.

11. The method of claim 10 in which the cooling fluid is circulated along the length of the lance.

12. The method of claim 11 in which the cooling fluid is directed from the end of the lance that is outside of the furnace to the end where the nozzle is located and back to the end of the lance that is outside of the furnace to effectively remove heat from the lance.
